(19) United States
(12) Patent Application Publication
(10) Pub. No.: US 2006/0248152 A1
(43) Pub. Date: Nov. 2, 2006

(54) System and method for collective communication over the human user network on the Internet

(75) Inventor: Lingmin Meng, Rolling Meadows, IL (US)

Correspondence Address: Lingmin Meng, 1421 Marilyn Ct., Rolling Meadows, IL, 60008, US

(73) Assignee: Mr. Lingmin Meng, Rolling Meadows, IL (US)

(21) Appl. No.: 11/308,202

(22) Filed: Mar. 10, 2006

Related U.S. Application Data
(60) Provisional application No. 60/594,743, filed on May 2, 2005.

(51) Int. Cl. G06F 15/16

(52) U.S. Cl. 709/206

(57) ABSTRACT

Disclosed is a system and method for providing networked users the ability to communicate messages efficiently and intelligently among themselves. Networked users can send and redirect messages to other users according to the content and intention of the messages. Human intelligence is applied when the users select to which of the other users to send or redirect messages. Through a plural of layers of redirection, the messages reach only the intended users or a particular set of users with the capability to provide a response to the received messages.

### CROSS-REFERENCE TO RELATED APPLICATION

This application claims the benefit of U.S. Provisional Application entitled “System and method for collective communication over the human user network on the Internet”, Ser. No. 60/594,743 filed May 2nd, 2005 which is incorporated herein by reference.

### SUMMARY OF INVENTION

This invention describes a system and method that supports three main functions: 1) an intelligent Internet search engine or a solution provider that integrates human knowledge of involved users through their selection of subset of users and through their responses to a sent message which is in the form of a question. 2) an intelligent Internet announcing mechanism that propagates announcements efficiently to the intended users through their selection of subset of users who might be interested in the particular announcement, without reaching a potentially large number of general users. 3) a message communication engine that hides the identity of the message originator through multiple layers of redirection.

### BACKGROUND OF INVENTION

Information is abundant to human beings with the help of powerful computers and the far-reaching Internet. Computer programs are capable of transferring and manipulating data in astonishing speed and accuracy. With the abundance of computer hardware and software programs such as web-pages, search engines, email and databases, a person seems to be able to find a particular piece of information, knowledge, or answer with ease.

On the other hand, a single person's skill and speed to process the information is very limited. Even the first task of locating the exactly pertinent piece of information from a plethora of available information might be intimidating. With the help of a modern Internet search engine, such as Google, this task can be mostly accomplished. The current progress of Artificial Intelligence is still unable to match human being in terms of generalizing and analyzing information. For a random example, a person is searching for a simple bit of information such as “the maximum jail sentence for arson in Texas”. An Internet search engine, given the keywords maximum, jail, sentence, arson, and Texas, may or may not be able to provide a straightforward answer, although it may return thousands of web page links. On the other hand, a human being understands that the question is seeking a number of years as the answer. A human legal expert is able to provide a number as an answer or to provide partial information by referring to a certain category in a library or to a certain law website.

Therefore, human interaction still plays an indispensable role in the process of transferring and exchange information and knowledge. Human judgment is needed in two stages: first, in selecting further the related information from the result of an Internet search engine; second, in finding the answer to a particular question from the selected information in the particular domain. The current invention is about a system and method that can facilitate the human communication process, making the communication process easier, efficient, and powerful.

It is believed that current Internet search engines do not use human intelligence directly. Typically, the user provides a few keywords, and then the search engine roams the WebPages or a database to search for the contents with the provided keywords. Because the human language is dynamically changing and the semantics are very complicated with exceptions to the programmed rules, sometimes a human being can interpret a question asked by another human being more accurately than a machine does. Therefore a computer system that allows human interaction is very important and sometimes provides better search results than by a machine.

In particular, the present invention facilitates the relationship between the senders and receivers in the process of human communication. The present invention addresses the selection of receivers for a particular message or response in the human communication process. It is the inventor's belief that the selection of receivers adds value to the communication of the information.

A particular question is better directed at a particular group of people than the general audience in order to have a maximum effect such as getting an answer to a question. There are many website communities and message boards over the Internet. However, it is difficult for people to keep track of so many communities, even more difficult when a user needs to enter login name and password for each website. A person can also be lost in a sea of messages posted on a message board that are not necessarily interesting to him/herself.

With every benefit, there is usually a cost. The progress for a user to get responses or answers is slow compared to Internet search engines. The process may take days or longer because human involvement is needed in the propagation of the original message although the propagation of responses is automatic. Therefore, the proposed system is particularly beneficial in communicating messages that do not necessarily require immediate responses. As examples, there are two types of such messages. The first type is a question seeking a specific answer such as the “maximum jail sentence for arson in Texas” in the aforementioned example. The second type is announcements. As an example of the second type, an announcement like “I would like to find carpooling partners to make frequent weekend trips between the two cities of Boston and New York”.

The present invention models the natural human-human communications. All the humans who use the proposed system, i.e. the users, form a collection of nodes that are virtually linked together. A link between a pair of nodes is called a direct link when there is no intermediate node between them. A pair of nodes that are linked by a direct link are called neighbors to each other. A user only needs to send a message to his/her direct neighbors. Then each of the neighbor receivers can select to resend the same message to his/her respective neighbors. The links are dynamic and temporary as each user has the freedom to send or redirect a message to any of the other users. The invention helps a user to forge a long-lasting relationship with neighboring users, to exchange information directly with neighboring users, and further exchange information indirectly with other users through the neighboring users.

This invention is partially motivated by the idea of artificial neural networks (ANN). In a typical ANN, a signal propagates through the numerous nodes, or neurons, which are interconnected with varying strength. The varying strength can be trained and optimized to generate the desired output for every specific input. In the present invention, each user acts like a neuron in the ANN in that: I) each user decides the link strength to other users for any particular message and resends the message only to those users with stronger linkage. II) Based on past experiences with sending messages and receiving responses, each user gradually gains the knowledge about other users or their respective neighbors and the knowledge can help to improve the likelihood of optimal responses or results.

The current invention also helps to reduce two common undesirable problems that are associated with natural human-human communications: privacy exposure and communication abuse.

The current invention keeps the privacy exposure at minimum. In a normal human communication environment such as in a human-human conversation, it is very hard to maintain the privacy of human identity. In many occasions, a person prefers to be anonymous in sending messages and retrieving responses. Even with an email system, the message body is directly associated with the sender's email address. Therefore, the identity of the sender is associated with the message body since there are no intermediate layers. The present invention minimizes the chances of revealing the user identities by a) not revealing any information that a user does not want to reveal; b) hiding the initial sender i.e. the originator of a message or a response from the receivers of the message or response as a result of multiple layers of redirection of the message or response. Although a message receiver knows from which user the message comes from, he/she can not resolve the ambiguity between a initial sender or just a redirector.

The current invention keeps the abuse (e.g. spam) contained and controlled. The email system is abused by people sending to unwilling receivers large number of advertisements. The present invention provides a user the option to block receiving messages from certain other users. At the judgment of each individual user, if the user receives a message that is considered spam, the receiver has the option to penalize the sender or redirector by blocking further messages from that user which sent or redirected the previous spam message. To avoid this penalty, a user would voluntarily refrain from sending or redirecting spam messages by his or her own judgment.

### DETAILED DISCRIPTION OF THE PREFERED EMBODIMENT

It is the inventor's belief that the proposed system could be implemented in practice by the skilled in the art. The proposed system is quite similar to the widely used email server systems.

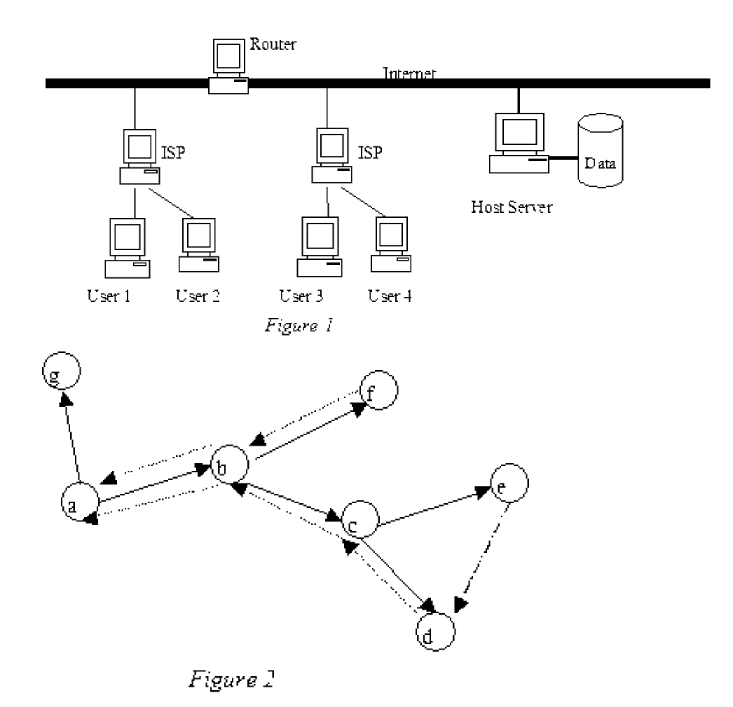

In the preferred embodiment, the physical configuration or environment of the proposed system is very common. As shown in the FIG. 1, the users' computers need to be connected (typically via an Internet Service Provider) to Internet when sending and receiving messages. The server is also connected to the internet at all times to process the request of sending or retrieving received messages and other system maintenance functions.

A typical user uses the proposed communication system by running a web browser at the user's computer. The typical user logs onto the server by providing user ID and password. The user can change password after login. Similar to the human-machine interface functions of an email account, a user can view the received messages in a summary view where only the title, the immediate sender's ID (not necessarily the originator of the message), and the date. In the summary view, the user can delete and sort the messages. The user can choose to view the message body of an individual message. For an individual message, the user can choose to reply and/or redirect to a number of other users by selecting their user ID(s). The user can arbitrarily block receiving messages from certain users by submitting the blocked user ID to the system. The user can edit and publish a number of keywords in his/her profile so that other users can search and identify the user in common interest.

The server is a computer or a cluster of computers, usually with high computation power and large data storage, processing the request of users and maintaining the integrity of the server system data. The core of the server's function is to manage a database of the users, their messages and links.

In the preferred embodiment, all the user information, messages and responses are stored in a relational database, which is managed by a Database Management System (DBMS). Relational databases gain their efficiency and flexibility from the fact that their data resides in tables that are largely independent of each other. One can add, delete, or change data in a table without affecting the data in the other tables, provided that the affected table is not a parent of any of the other tables. A table, also commonly called a relation, is a two-dimensional array of rows and columns, containing single-valued entries and no duplicate rows.

The relational database consists of many tables. The modeling of the data should avoid redundancy and ensure flexibility to retrieve and modify records. The base tables are essential for the operation of the system and other tables, or “views”, can be derived from the base tables. The operations are usually provided by DBMS to manage the base tables or views. Such operations include: insert or delete records, retrieve records, join tables, projections, etc. The base tables can be defined using Data Definition Language (DDL) as follows:

| CREATE TABLE User { | |
|---|---|
| user_id | CHARACTER (30) PRIMARY KEY, |
| password CHARACTER (10), | |
| user_name CHARACTER (30), | |
| profile | CHARACTER (500), |
| }; | |

For each keyword in each user's profile, there is a corresponding entry in the table named profile. Therefore a particular user with multiple keywords will create the same number of records with identical user_id but different keyword entries in the table.

```
CREATE TABLE Profile {
    user_id  REFERENCES User (user_id),
    keyword  CHARACTER (20)
};
```

According to the preferred embodiment of the present invention, the system sets up a plural of interest groups to facilitate the initial discovery of users with common interests. Such interest groups can be identified by a certain keyword in the public domain. For example, “auto” can be used to identify the group of users who are interested in automobile topics. Each user may want to associate with any of the published groups by associating his/her user_id with the said group keyword. Therefore, any user is able to identify a particular group of users by query the database for the users that are associated with a particular keyword. Subsequently, he/she can send or relay a message to any of the identified users.

According to the preferred embodiment of the present invention, a user can request to prevent receiving any messages directly from a second user. The first user submits a request to the system by providing the user_id of the said second user. The system adds a record per request to a table named Blockage, which can be created by the following statement:

```
CREATE TABLE Blockage {
    Requester  REFERENCES User (user_id),
    Blocked_user REFERENCES User (user_id)
}
```

A user can initiate a message by requesting the system to add a record in the table named Message. The message body can be a block of text, or a symbolic address of an allocated storage space where text, audio, video or any other file attachment submitted by the user are stored. The table Message can be created by the following statement:

| CREATE TABLE Message { | |
|---|---|
| message_id INTEGER PRIMARY KEY, | |
| user_id | CHARACTER (30), |
| message_date | DATE, |
| message_body | CHARACTER (1000), |

```
    CONSTRAINT user_fk FOREIGN KEY (user_id)
        REFERENCES User (user_id)
};
```

After a message is created, the initial sender can send it to another user. A receiver of any message can re-send the said message to any other user. Such sending can be achieved by submitting requests to the system and providing the message_id, sender_id, and receiver_id. The system inserts a record per request in the table name Forward_leg, which can be created by the following statement:

| CREATE TABLE Forward_leg { | |
|---|---|
| leg_id | INTEGER PRIMARY KEY, |
| message_id | INTEGER, |
| leg_date | DATE, |
| sender_id | CHARACTER (30), |
| receiver_id | CHARACTER (30), |

```
    CONSTRAINT user_fk FOREIGN KEY (sender_id)
        REFERENCES User (user_id),
    CONSTRAINT user_fk FOREIGN KEY (receiver_id)
        REFERENCES User (user_id),
    CONSTRAINT msg_fk FOREIGN KEY (message_id)
        REFERENCES Message (message_id)
};
```

The system performs a “join” operation of the Forward_leg and Blockage tables to exclude any blocked messages so that the blocked messages will not appear in the receiver's incoming mailbox.

When a receiver of a message wants to supply a response, the receiver can request the system to insert a record in the table named Response, which is created by the following statement:

| CREATE TABLE Response { | |
|---|---|
| response_id | INTEGER PRIMARY KEY, |
| message_id | INTEGER, |
| leg_id | INTEGER, |

| response_date | DATE, |
|---|---|
| response_body | CHARACTER (1000?), |
| CONSTRAINT leg_fk | FOREIGN KEY (leg_id) |
| REFERENCES Forward_leg (leg_id), | |
| CONSTRAINT msg_fk | FOREIGN KEY (message_id) |

REFERENCES Message (message_id)
};

If the system receives a response from a user, it traces the corresponding senders from whom the said user receives the message directly and indirectly. Then the system posts the response to all the corresponding senders as if their respective direct receivers supply the responses.

In some occasions after the initial sender receives a response, the initial sender needs to communicate further with the original responder. For example, the initial sender posts a message selling her/his car. After several layer of the message propagation, a receiver is interested and responds with some additional questions. The initial sender then wants to answer the additional questions. Such answers need to reach the original responder without necessarily any action of the intermediate senders. In order not to compromise any identity exposure, the answers will travel along the initial path, or a “channel” and reach the original responder.

In some other occasions after the initial sender sends out a message, he/she wants to withdraw the sent message so that no one can make further propagation of the message. For example, the car is sold in the aforementioned example. Once the initial message is withdrawn, the message disappears or becomes inactive so that nor further propagation of the said message can be made by any receiver and no response can be made.

In some further other occasions after a message has lived in the network for a certain period of time, an intermediate sender may want to withdraw the message he/she has relayed. For example, the responses for a particular message become overwhelming and no further responses are needed in his/her judgment but the initial sender has not withdrawn the message. The said intermediate sender may want to withdraw the message so that it becomes inactive or disappears in only of those receivers who get the message from the said intermediate sender directly or indirectly. The initial sender can still receive responses from other branches.

FIG. 2 illustrates an example of the process of sending and receiving an example message. In this example, user ‘a’ originates a message (e.g., a question asking for a piece of information about a high school in the village of Schaumburg, Ill.). For whatever reason based on past experiences (e.g., that user ‘g’ sent user ‘a’ some message about a restaurant in the same village, and user ‘b’ sent user ‘a’ some message about the house market in the same village, which means both user ‘g’ and user ‘b’ or other users linked to them have some knowledge about the same village), user ‘a’ sends this question to user ‘b’ and ‘g’. User ‘b’, in turn redirects the message to user ‘c’ and user ‘f’. Then user ‘c’ forwards the message to both user ‘e’ and user ‘d’. Then user ‘e’ tries to forward the message to user ‘d’. Since the system knows that user ‘d’ has already got the message from user ‘c’, user ‘e’s sending message to user ‘d’ fails, therefore user ‘d’ only receives a single copy of the message. Afterwards, user ‘f’ replies to user ‘b’ by providing the requested information. User ‘d’ replies to user ‘c’ by providing the requested information independent of the reply from user ‘f’ to user ‘b’. Both of the replied responses reach to user ‘a’ without any action from user ‘b’ or user ‘c’. Both user ‘b’ and user ‘c’, however, are able to view the response from their respective repliers. That is, user ‘b’ can view the responses from user ‘f’ and user ‘d’. User ‘c’ can view the response from user ‘d’.

The message communication experience in the above described example helps the users to better know their neighbor users' knowledge base, thus provides hints in future message communications. That is, user a will more likely ask questions about the village of Schaumburg to user b. User b will more likely ask similar question to user a, user f, and user c. User c will more likely ask similar questions to user b and user d. User d will more likely ask similar questions to user c.

The description of the embodiment is intended to be illustrative, not limitative. Thus, it will be apparent to one skilled in the art that certain modifications may be made to the invention as described without departing from the scope of the claims.

### REFERENCES

The Design of relational databases. H. Mannila, K J Raiha. Addison-Wesley Publishing Co.

What is claimed is:

1. A system and method that provides a group of human users with the ability to communicate messages with each other on the Internet, the system comprising:
computer means that allows any of the said group of users to send a message to an arbitrarily user-selected subset of the said group of users;
computer means that allows the said sender to receive the response from any of said subset of users; and
computer means that allows each of the said subset of users to receive the said message, and to respond and/or to relay the said message to a second arbitrarily user-selected subset of the said group of users,
wherein the said message and the said response propagate in the said user group by being sent and relayed for multiple times with aforementioned computer means.

2. The system and method of claim 1, wherein the responses to the said message are sent back automatically to the initial sender.

3. The system and method of claim 2, wherein a channel is set up between the said user who sends the said message and the said user who replies with the said response to the said message, further messages and responses can be communicated through the said channel back and forth without any action from the intermediate users.

4. The system and method of claim 2, wherein a message is a question or an announcement in the form of text, image, or sound files and wherein a response is an answer to the said question or a response to the said announcement.

5. The system and method of claim 2, wherein a message can be withdrawn by the initial sender so that the said message is no longer available to any of the receivers.

6. The system and method of claim 5, wherein a message can be withdrawn by any redirecting user so that the said message is no longer available to any of the receivers who received the said message from the said redirecting user directly or indirectly.

7. The system and method of claim 2, wherein each user maintains a profile that is searchable by other users to decide the subset of users to send or relay a message. The profile includes a plural of user-defined keywords or phrases (an ordered plural of keywords), and/or includes a plural of associations with any groups that are defined by keywords.

8. The system and method of claim 2, wherein each user is provided with ability to view the record of the messages that are sent or relayed or received by him/herself in history, the said record shows the content and the sender from whom each message or response is sent or relayed.

9. The system and method of claim 2, wherein each user is provided with the ability to block any message from a second user so that the message sent or relayed by the said second user to the said first user is blocked by the system.

10. The system and method of claim 7, wherein the users are provided with ability to identify the users whose profiles match the user-entered criteria, the said criteria is a logical combination of profile keywords, phrases, and associated groups. Furthermore, the users are provided with ability to send or relay messages to the said identified subset of users.
